(19) United States
(12) Patent Application Publication
(10) Pub. No.: US 2011/0199538 A1
(43) Pub. Date: Aug. 18, 2011

(54) DIGITAL PHOTO-FRAME ANYWHERE

(76) Inventor: Erik David Gershfeld, Chicago, IL (US)

(21) Appl. No.: 12/708,527

(22) Filed: Feb. 18, 2010

(51) Int. Cl. H04N 3/27; H04N 7/18

(52) U.S. Cl. 348/554; 725/81; 348/E03.049; 348/734; 348/E05.096

(57) ABSTRACT

A system for displaying digital photographs and video on the screen of a TV receiver using a digital photo-frame device connected to the TV receiver. The digital photo-frame device has a slot for receiving AC power, a USB slot for receiving digital pictures, and a slot for receiving at least one storage medium having digital photographs or videos thereon. A processor which communicates with a TV remote control thru the TV receiver executes logic based on signals from the remote control to designate one or more digital photographs or videos on the at least one storage medium for viewing on the screen of the TV receiver, and designate one or more digital photographs or video received at the USB slot for viewing on the screen of the TV receiver.

### BACKGROUND OF THE INVENTION

1. Field of the Invention

The present invention relates generally to a system and method for viewing digital photos, and more particularly to instantly viewing photos that are on a SD card on the screen of a TV receiver.

2. Description of Related Art

Viewing digital pictures and video is known in the prior art. More specifically, by way of example, U.S. PreGrant Publication No. 2009/0231233 to Liberatore discloses a portable digital photo album that allows a user to view and store photos, videos, and other digital media. The digital photo album disclosed is intended to replace the typical photo album. The digital album includes a display unit for displaying digital media, and a storage location for storing digital media to be displayed on at least one display unit. It is intended that the digital photo album change the way digital photos are viewed. Typically, digital photos are viewed on a camera or cell phone, or immediately thereafter when uploaded to a computer or a backup device, or when printed. Using the digital album, a user can store and view collections of photos at a moment's notice and in a single portable location.

US PreGrant Publication No. 2005/0162555 to Lan, et al., discloses a digital photo frame device which has a buffer unit that temporarily stores TV signals to be displayed or processed, a compression/decompression engine coupled to the buffer unit for compressing TV signals into an image file or decompressing an image file into TV signals, a video processor which displays the TV signals on a display unit, and an OSD clock display unit that records the current time and stores an OSD time pattern in advance. The OSD clock display unit determines a real-time clock pattern to be displayed and the position of the display, according to the recorded current time and the corresponding OSD time pattern selected when the video processor displays a pre-determined clock background pattern so that the clock background pattern and the real-time clock pattern overlying over the clock background pattern are displayed on the video display in an OSD fashion.

U.S. Pat. No. 7,352,407 to Lan, et al., discloses a digital photo frame device, which has a buffer unit for temporarily storing TV signals whish are displayed or processed; a compression/decompression engine coupled to the buffer unit for compressing TV signals in the buffer unit into an image file or decompressing an image file into TV signals; a video processor for displaying the TV signals temporarily stored in the buffer unit on a display unit; an external storage device pre-saved with data representing various clock background patterns; an interface unit coupled to the buffer unit to write data from the buffer unit to the external storage device or data from the external storage device to the buffer unit; and an OSD clock display unit for recording the current time and storing at least an OSD time pattern in advance; wherein the clock background pattern pre-saved in the external storage device is written to the buffer unit by means of the interface unit so as to be displayed, and wherein the OSD clock display unit determines a real-time clock pattern to be displayed and a position of the display according to the recorded current time and the corresponding OSD time pattern selected when the video processor displays the clock background pattern so that the clock background pattern and the real-time clock pattern overlying over the clock background pattern are displayed on the video display in an OSD fashion.

US PreGrant Publication No. 2009/0262135 to HUSTON, et al., displays on a TV multiple image layers that may be still or moving video, photos, etc, or a combination thereof which can be overlaid on each other.

U.S. Pat. No. 7,274,482 to Yeh, et al., discloses viewing digital photographs on a television by inserting into the TV a Memory Stick, RTM or other removable medium bearing the photos. Using the TV remote control, viewers can select photos for printing, as well as the quantity to be printed. Viewers can also cause only those photos that have been selected for printing to be displayed, to facilitate further refining the print list. Then, the removable medium can be removed from the TV and inserted into a photo printer to print the selected photos.

U.S. Pat. No. 6,961,904 to Pilu discloses a system for displaying a user's personal digitized photographic image data in a comparable manner to a photo album. The system includes a gaming console for playing a video game; a television for displaying the video game to the user when connected with the console; and a CD including the user's digitized photographic image data and a viewing application program. The viewing application program is arranged to configure the gaming console to display the digitized photographic image data on the television when the CD has been read by the gaming console. The system can be configured to permit simultaneous viewing of the user's image data at remote locations which are connected to the Internet.

### SUMMARY OF THE INVENTION

In an exemplary embodiment of the present invention, there is disclosed a method and system for displaying digital photographs on the screen of a TV receiver having a TV tuner for presenting television content, a digital photo-frame device adapted to be connected to the TV receiver, and a user operable control device coupled to the digital photo-frame device and to the TV receiver, the digital photo-frame device comprising:

a slot for receiving AC power;

a USB slot for receiving digital pictures

a slot for receiving at least one storage medium having digital photographs thereon and being removable coupled to a camera for receiving digital photographs which are to be displayed on the screen of the TV receiver;

a processor communicating with the user operable control device and the storage medium when the storage medium having digital photographs thereon is inserted into the slot in the digital photo-frame device, the processor executing logic including at least one of:

based on signals from the user operable control device, designating one or more digital photographs on the at least one storage medium for viewing on the screen of the TV receiver;

based on signals from the user operable control device, designating one or more digital photographs received at the USB slot for viewing on the screen of the TV receiver.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a block diagram of an exemplary embodiment of a digital photo-frame device which, when connected to a TV receiver, allows a user to immediately view digital photos on the screen of the TV receiver via a USB port on the digital photo-frame device or an SD card located in a port on the digital photo-frame device in accordance with the principles of the invention;

FIG. 2 is a flow diagram of the logic in accordance with the principles of the invention;

FIG. 3 is a block diagram of a menu which is displayed on the screen of the TV receiver in accordance with the principles of the invention;

FIG. 4 is a block diagram of various functions which, when displayed on the screen of a TV receiver, are available for selection by a viewer in accordance with the principles of the invention; and

FIG. 5 is a block diagram of an exemplary embodiment of another embodiment of a digital photo-frame device which, when connected to a TV receiver, allows a user to immediately view digital photos on the screen of the TV receiver via a USB port on the digital photo-frame device or an SD card located in a port on the digital photo-frame device in accordance with the principles of the invention.

### DESCRIPTION OF THE PREFERRED EMBODIMENT

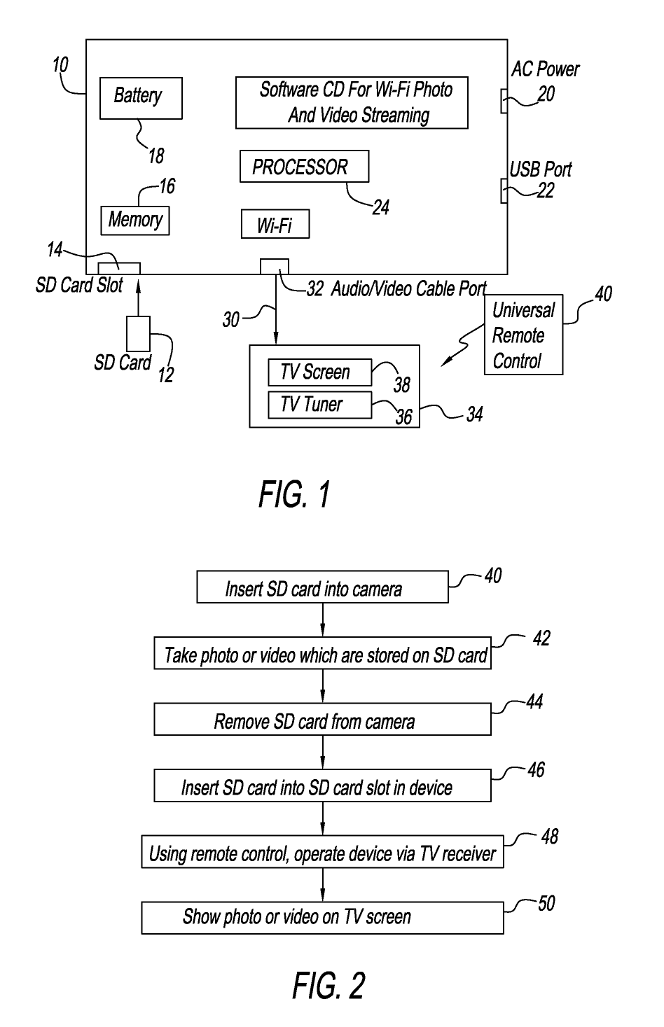

Referring to FIG. 1 there is shown a block diagram of an exemplary embodiment of a digital photo-frame device which, when connected to a TV receiver, allows a user to immediately view digital photos on the screen of the TV receiver which are received on a USB port on the digital photo-frame device or are on Secure Digital (SD) card located in a port on the digital photo-frame device. Initially, using a digital camera (not shown), a person takes a number of pictures which are stored on a SD card located in the camera. At some time thereafter, when the photos are to be viewed, the user takes the SD card 12 out of the camera and inserts it into an SD card slot 14 in the digital photo-frame device 10. Device 10 is portable and allows a user to use any TV receiver to easily and conveniently view digital photos and video stored on the SD card. The TV receiver can be any digital receiver including a high definition TV receiver.

The SD card on which the digital photos or video are stored is a relatively small portable solid state memory device manufactured by various companies which is inserted into a port on the camera for receiving and storing digital photos or video. When the digital photos or video on the SD card is to be viewed, the card is removed from the camera and inserted into an SD card slot in the digital photo-frame device 10 where the contents on the SD card are loaded onto memory 16.

The digital photo-frame device 10 includes WI-FI capability which provides data streaming from any computer to allow a user to upload digital photos, video, and music on memory 16. Device 10 also includes a rechargeable eight hour Lithium Ion battery 18, a standard AC power port 20, and can operate at 128 MB, 256 MB, 512 MB, 1 GB, 2 GB, 4 GB, 8 GB or 16 GB.

The SD card allows a user to take the SD card from a camera and place it into the digital photo-frame device to immediately view the digital photos or video on the screen of a TV receiver. The digital photo-frame device includes a USB port 22 which can be used for uploading the memory 16 with digital photos or video and for charging the Lithium Ion rechargeable battery. One or more standard cables 30 are provided for connecting the digital photo-frame device from an audio/video port 32 to older TVs and component cables are provide for high quality pictures and video enjoyment. A remote or a universal remote is used for positioning a curser on a menu that is displayed on the TV receiver for controlling the digital photo-frame device A processor 24 located in device 10 includes program code that embodies logic which is used in the operation of the device. A TV tuner 36 located in the TV receiver provides programming for the receiver.

This embodiment of the digital photo-frame device has the following features: a capacity of 128 MB, 256 MB, 512 MB, 1 GB, 2 GB, 4 GB, 8 GB, or 16 GB; WI-FI capability; a rechargeable Lithium Ion eight hour battery; supports photo MP3 and video file formats; and includes a CD having software for WI-FI, photo and video streaming. The device 10 allows a user to turn any TV receiver into a digital photo-frame by connecting the device to a TV receiver and uploading digital pictures and video directly from the USB port or from an SD card that is inserted into the device.

With this invention a person can easily and conveniently view digital photos and videos which are displayed on screen 38 of a TV receiver using a conventional wireless TV remote control device 40 having buttons with arrows for moving a curser on the TV receiver up, down, left and right, a select button and numeric buttons.

Referring to FIG. 2, there is shown a flow diagram of logic in accordance with the principles of the invention. Starting at block 40, a person inserts a SD card into a digital camera prior to taking any pictures. The person using the camera takes pictures which are stored on the SD card in the camera, block 42. When the pictures are to be viewed, the SD card is removed from the camera, block 44, and is inserted into the SD card slot in Digital photo-frame device, block 46. Using the remote control, the user operates the device via the TV receiver to show the pictures or video, block 48, and views the various photos or video on the screen of the TV receiver, block 50.

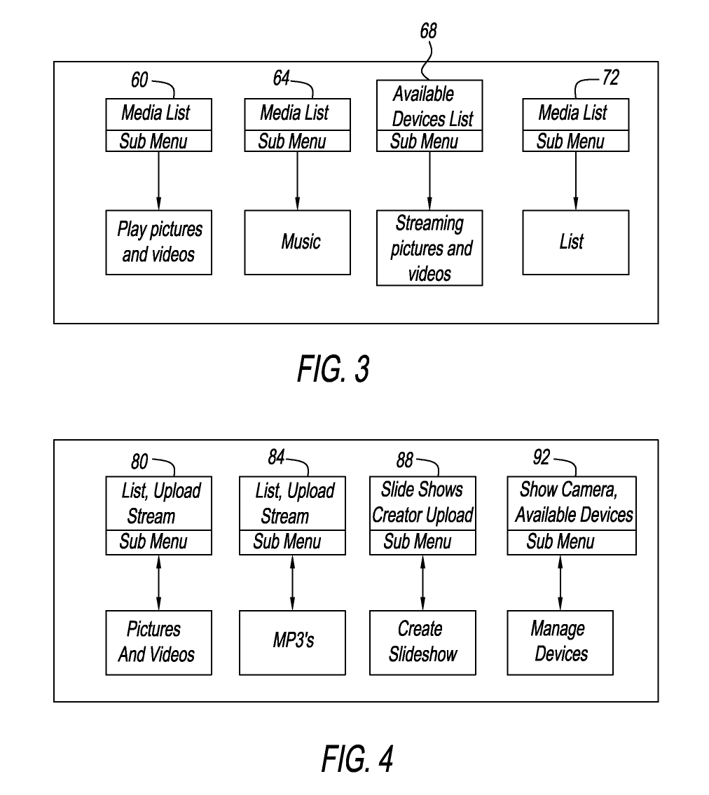

Referring to FIG. 3, there is shown a block diagram of a menu which is displayed on the screen of the TV receiver in accordance with the principles of the invention. The various functions of the menu displayed can be selected by using the arrow buttons of the universal remote to position a curser on top of the function desired and then pressing the select button on the remote. In an exemplary embodiment, selecting box 60 will display a media list and show a sub-menu for playing pictures and videos. Selecting box 64 will display a music list and show a sub-menu for playing music. Selecting box 68 will display a list of available devices and show a sub-menu for streaming pictures and video. Selecting box 72 will display a media list and show a sub-menu for the list.

Referring to FIG. 4, there is shown a block diagram of various functions which, when displayed on the screen of a TV receiver, are available for selection by a viewer in accordance with the principles of the invention. Box 80 is the software for uploading pictures or videos on the SD card to the screen of the TV receiver. Box 84 is the software for uploading a MP3 player. With a MP3 payer, a user can create personalized music lists and have access to thousands of songs. Some devices provide additional technology, like video and photo viewing. Box 88 is the software for uploading and showing the digital pictures or video on the screen of a TV receiver. Box 92 is the software for showing the available devices such as cameras and other available devices.

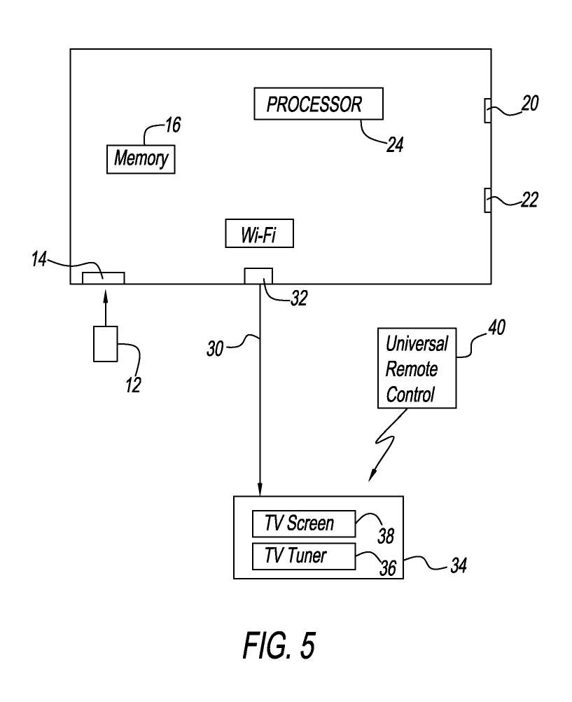

Referring to FIG. 5, there is shown a block diagram of an exemplary embodiment of another embodiment of a digital photo-frame device which, when connected to a TV receiver, allows a user to immediately view digital photos and videos on the screen of the TV receiver via a USB port on the digital photo-frame device or an SD card located in a port on the digital photo-frame device.

Initially, using a digital camera (not shown), a person takes a number of pictures which are stored on a Secure Digital (SD) card located in the camera. At some time thereafter, when the pictures are to be viewed, the user takes the SD card 12 out of the camera and inserts it into the SD card slot 14 in the digital photo-frame device 10. Device 10 is portable and allows a user to turn any TV receiver into a digital photo-frame to easily and conveniently view each of the pictures or videos on the SD card. The TV receiver can be any digital receiver including a high definition TV receiver.

The SD card on which the photographs are stored is a relatively small portable solid state memory device manufactured by various companies which is inserted into a slot on the camera for receiving digital photos or videos. When the photos or videos on the SD card are to be viewed, the card is removed from the camera and inserted into the SD card slot in the digital photo-frame device 10 where the contents on the SD card are uploaded and stored on memory 16. Processor 24 communicates with memory for accessing the photos or videos. Digital photo-frame device 10 also includes a standard AC power slot 20. The digital photo-frame device can support 1 GB, 2 GB and 4 GB and can receive an SD card from a digital camera to allow a user to instantly view the photos or videos from the SD card on the screen of a TV receiver. A USB port 22 is provided for uploading the memory with pictures. Standard cables are provide for connecting the digital photo-frame device to older digital TVs, and component cables are provide for high quality pictures and video enjoyment. A wireless remote is used to show digital photos and videos on the screen of a TV receiver. A processor 24 in the digital photo-frame device 10 can accesses memory 16. A TV tuner 36 provides programming for the TV receiver. Cable 30 connects audio/video port 32 in the device 10 to TV receiver 34.

In the embodiment shown in FIG. 5, the viewer can view digital or video photo on the screen using a conventional wireless TV remote control device 40. This embodiment of the digital photo-frame device has the following features: a capacity of 1 GB, 2 GB and 4 GB; and supports all photo MP3 and video file formats. It does not have WI-FI capability, does not have a rechargeable battery; and does not have the ability to run software. It does allow a user to turn any TV receiver into a digital photo-frame by uploading digital pictures directly to the digital photo-frame device via the USB port or by inserting an SD card into the device and connecting it to a TV receiver.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system for displaying digital photographs on the screen of a TV receiver having a TV tuner for presenting television content, a digital photo-frame device adapted to be connected to the TV receiver, and a user operable control device coupled to the digital photo-frame device and to the TV receiver, said digital photo-frame device comprising:
a slot for receiving AC power;
a USB slot for receiving digital pictures
a slot for receiving at least one storage medium having digital photographs thereon and being removable coupled to a camera for receiving digital photographs which are to be displayed on the screen of the TV receiver;
a processor communicating with the user operable control device and the storage medium when the storage medium having digital photographs thereon is inserted into the slot in the digital photo-frame device, the processor executing logic including at least one of:
based on signals from the user operable control device, designating one or more digital photographs on the at least one storage medium for viewing on the screen of the TV receiver;
based on signals from the user operable control device, designating one or more digital photographs received at the USB slot for viewing on the screen of the TV receiver.

2. The system of claim 1 wherein said user operable control device is a TV receiver remote control device.

3. The system of claim 1 wherein said user operable control device is a universal TV receiver remote control device.

4. The system of claim 1 wherein a rechargeable battery is located within the digital photo-frame device.

5. The system of claim 1 wherein the rechargeable battery is a lithium Ion battery.

6. The system of claim 1 wherein the digital photo-frame device has WI-FI capability.

7. The system of claim 1 wherein the digital photo-frame device has WI-FI capability.

8. The system of claim 1 wherein the digital photo-frame device includes software for WI-FI, photo and video streaming.

9. The system of claim 1 wherein the digital photo-frame device can operate at 128 MB, 256 MB, 512 MB, 1 GB, 2 GB, 4 GB, 8 GB or 16 GB.

10. The system of claim 1 wherein the digital photo-frame device supports photo, MP3 and video file formats.

11. A system for displaying digital photographs on the screen of a TV receiver having a TV tuner for presenting television content, a digital photo-frame device adapted to be connected to the TV receiver, and a user operable control device coupled to the digital photo-frame device and to the TV receiver, said digital photo-frame device comprises:
a slot for receiving AC power;
a USB slot for receiving digital pictures
a slot for receiving at least one storage medium having digital photographs thereon and being removable coupled to a camera for receiving digital photographs which are to be displayed on the screen of the TV receiver; and
a processor communicating with the user operable control device and the storage medium when the storage medium having digital photographs thereon is inserted into the slot in the digital photo-frame device, the processor executing logic including at least one of:
based on signals from the user operable control device, designating one or more digital photographs on the at least one storage medium for viewing on the screen of the TV receiver;
based on signals from the user operable control device, designating one or more digital photographs received at the USB slot for viewing on the screen of the TV receiver.

12. The method of claim 11 wherein said user operable control device is a TV receiver remote control device.

13. The method of claim 11 wherein said user operable control device is a universal TV receiver remote control device.

14. The method of claim 11 wherein a rechargeable battery is located within the digital photo-frame device.

15. The method of claim 14 wherein the rechargeable battery is a lithium Ion battery.

16. The method of claim 11 wherein the digital photo-frame device has WI-FI capability.

17. The method of claim 11 wherein the digital photo-frame device has WI-FI capability.

18. The method of claim 11 wherein the digital photo-frame device includes software for WI-FI, photo and video streaming.

19. The method of claim 11 wherein the digital photo-frame device can operate at 128 MB, 256 MB, 512 MB, 1 GB, 2 GB, 4 GB, 8 GB or 16 GB.

20. The method of claim 11 wherein the digital photo-frame device supports photo, MP3 and video file formats.
